(19) United States
(12) Patent Application Publication
(10) Pub. No.: US 2018/0312092 A1
(43) Pub. Date: Nov. 1, 2018

(54) Head Rest Apparatus

(71) Applicant: Shugla Karzai, Tustin, CA (US)

(72) Inventor: Shugla Karzai, Tustin, CA (US)

(21) Appl. No.: 15/959,850

(22) Filed: Apr. 23, 2018

Related U.S. Application Data
(60) Provisional application No. 62/492,948, filed on May 1, 2017.

(51) Int. Cl. B60N 2/882; B60N 2/885; A47C 7/38

(52) U.S. Cl. CPC B60N 2/882; B60N 2/818; A47C 7/383; B60N 2/885

(57) ABSTRACT

A head rest apparatus for cradling and supporting a head of a sitting passenger in a seat is provided. The seat has a seat portion and a backrest portion extending from the seat portion. The head rest apparatus comprises a strap securable about the backrest portion of the seat. A first head rest assembly is slidably securable to the strap and a second head rest assembly is slidably securable to the strap. The first head rest assembly and the second head rest assembly offer the passenger a full measure of support and comfort.

### CLAIM OF PRIORITY

This patent application claims priority under 35 USC 119 (e) (1) from U.S. Provisional Patent Application Ser. No. 62/492,948 filed May 1, 2017, of common inventorship herewith entitled, “Comfort Ride,” which is incorporated herein by reference as though the same were set forth in its entirety.

### FIELD OF THE INVENTION

The present invention pertains to the field of head rests for seats of airplanes, trains, cars, and buses, and more specifically to the field of head rests for seats of airplanes, trains, cars, and buses providing a pair of adjustable, soft and cushioning, side mounted head rests designed to offer travelers a full measure of support and comfort.

### BACKGROUND OF THE INVENTION

Millions of people travel each year by bus, train, plane, or automobile and wish the experience were more comfortable than it is. For passengers in these conveyances, there is the rear-mounted head-rest, which does relatively little to promote comfort. There are compact neck-pillows that one might buy for use in the seats of buses, trains, subways, ferries, and airliners; and there is sometimes the pillow one can get from the flight attendant. But none of these solutions is really satisfactory, for none of them gives any support from the side. It would be desirable to correct this deficiency in a simple and neatly designed manner, and make travel a far more comfortable experience.

The prior art has put forth several designs for head rests. Among these are:

U.S. Pat. No. 4,130,318 to Marcel Hemmen et al provides a seat having a headrest wherein a side pad is mounted on a support attached to a lateral portion of the seat, bracketed to the back, and an adjusting mechanism permits setting the height of the pad.

U.S. Pat. No. 7,093,903 to Richard W. O'Connor provides a headrest with pivotable side support members and safety features. A head support assembly according to one embodiment includes a first wing member including a deformable plastic wing frame portion. The head support assembly also includes a center member that includes a plastic center frame portion to which the first wing member is pivotably coupled. The forward pivoting of the first wing member is limited an acute angle.

U.S. Pat. No. 5,975,638 to Kevin E. Schreiner provides a dual unit to gently and user adjustably support a user's head from slumping either too much forward or too much to either side while allowing proper air circulation for user comfort when the user is in an upright position with the unit releasably held to a chair back is disclosed.

None of these prior art references describe the present invention.

### SUMMARY OF THE INVENTION

It is an object of the present invention to provide head rests for seats of airplanes, trains, cars, and buses providing a pair of adjustable, soft and cushioning, side mounted head rests designed to offer travelers a full measure of support and comfort.

The present invention is a head rest apparatus for cradling and supporting a head of a sitting passenger in a seat. The seat has a seat portion and a backrest portion extending from the seat portion. The head rest apparatus comprises a strap securable about the backrest portion of the seat. A first head rest assembly is slidably securable to the strap and a second head rest assembly is slidably securable to the strap. The first head rest assembly and the second head rest assembly offer the passenger a full measure of support and comfort.

In addition, the present invention includes a method for cradling and supporting a head of a sitting passenger in a seat. The seat has a seat portion and a backrest portion extending from the seat portion. The method comprises securing a strap about the backrest portion of the seat, slidably securing a first head rest assembly to the strap, slidably securing a second head rest assembly to the strap, and offering the passenger a full measure of support and comfort.

The present invention further includes a head rest apparatus cradling and supporting a head of a sitting passenger in a seat. The seat has a seat portion and a backrest portion extending from the seat portion. The head rest apparatus comprises an adjustable strap securable about the backrest portion of the seat. A first head rest assembly having a first mounting sleeve slidably is mounted to the strap, a first mounting bracket is secured to the first mounting sleeve, an adjustable first head rest support is rotatably mounted to the first mounting bracket, and a first head rest is mounted to the first head rest support. A second head rest assembly having a second mounting sleeve is slidably mounted to the strap, a second mounting bracket is secured to the second mounting sleeve with an adjustable second head rest support rotatably mounted to the second mounting bracket, and a second head rest is mounted to the second head rest support. The first head rest assembly and the second head rest assembly offer the passenger a full measure of support and comfort.

### BRIEF DESCRIPTION OF THE DRAWINGS

FIG. 1 is a perspective view illustrating a seat incorporating head rest apparatus, constructed in accordance with the present invention.

FIG. 2 is a close-up perspective view illustrating the head rest apparatus, constructed in accordance with the present invention.

FIG. 3 is still another close-up perspective view illustrating the head rest apparatus, constructed in accordance with the present invention.

FIG. 4 is a rear perspective view illustrating the seat incorporating the head rest apparatus, constructed in accordance with the present invention.

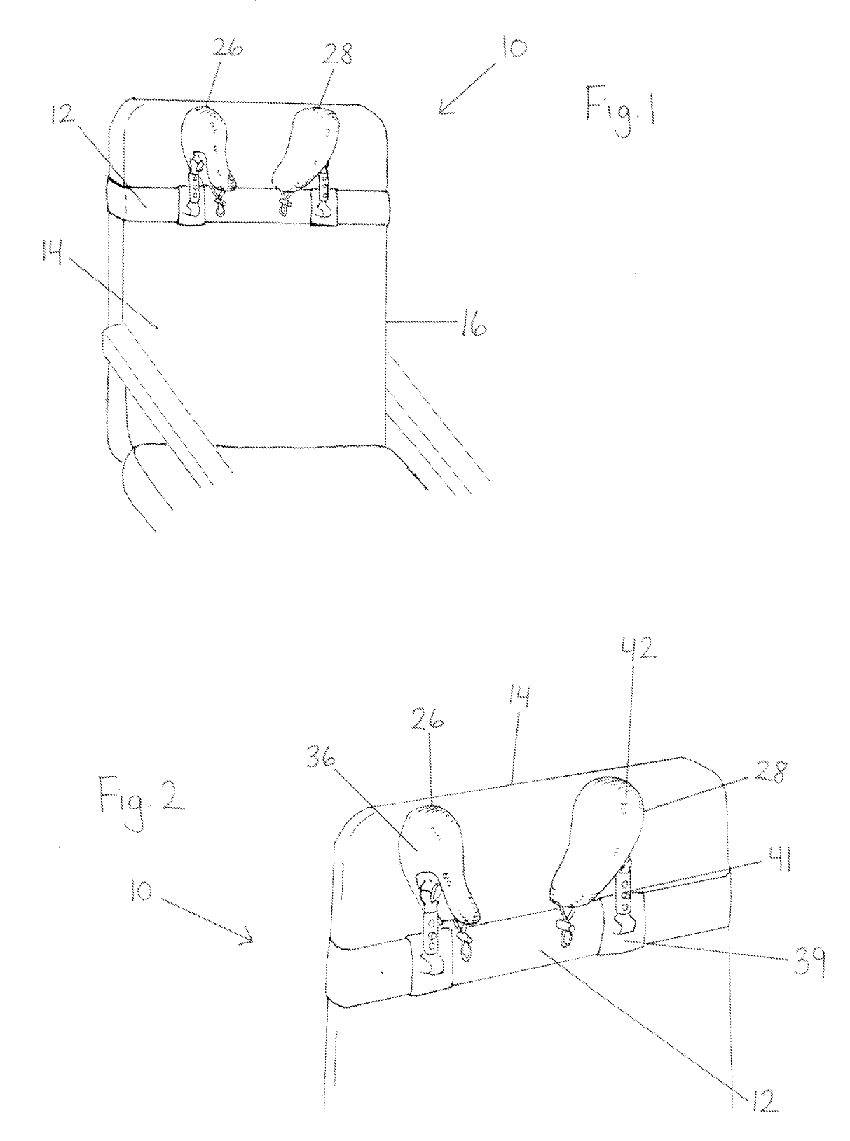

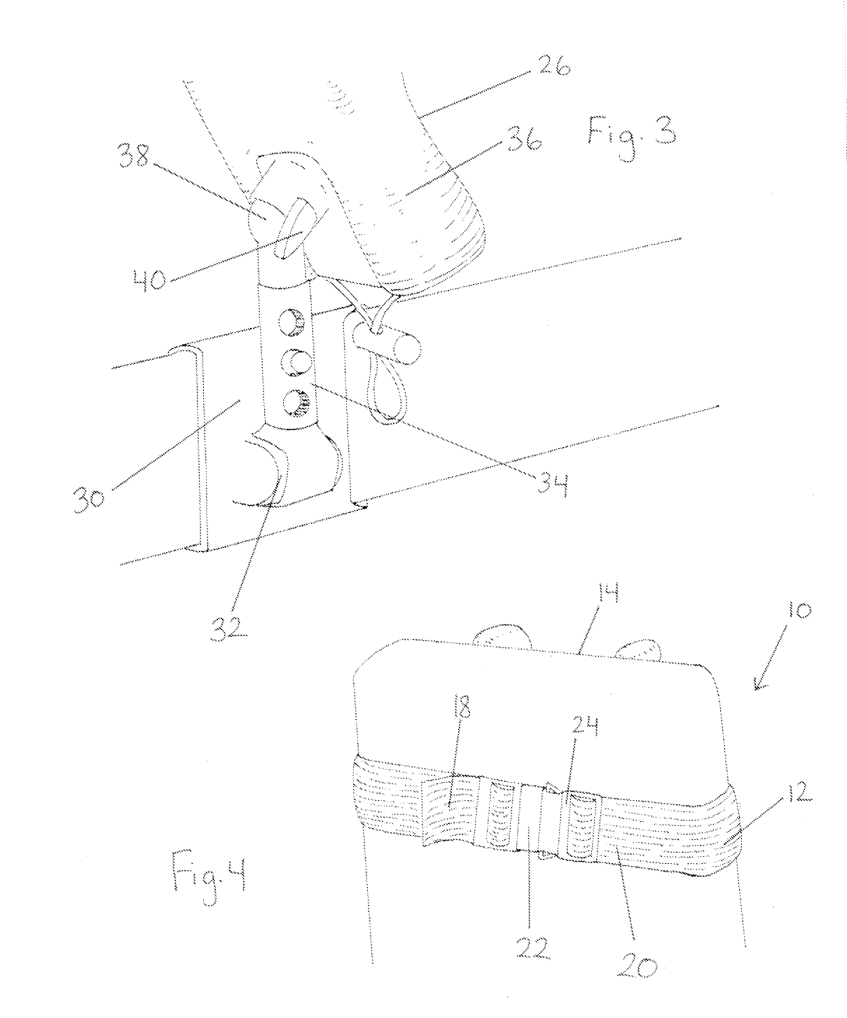

### DETAILED DESCRIPTION OF INVENTION

The present invention is a Head Rest Apparatus, indicated generally at 10, providing a pair of adjustable, cushioning head rests designed to cradle and support the head of a sitting passenger, in a car, plane, train, or bus, from either side. The Head Rest Apparatus 10 can be produced for removable or permanent installation on the seats of cars, airliners, trains, and buses. The Head Rest Apparatus 10 can also be produced as an add-on, aftermarket accessory, easily installed and easily removed between uses, for carry-on use on public transport, as well as use with cars, vans, SUVs, and pickups.

The Head Rest Apparatus 10 of the present invention includes an adjustable strap 12 securable about a backrest 14 of a seat 16. The strap 12 has a first end 18 and a second end 20 with a first buckle portion 22 secured to the first end 18 of the strap 12 and a second buckle portion 24 secured to the second end 20 of the strap 12. The first buckle portion 22 is releasably securable to the second buckle portion 24 to releasably secure the strap 12 about the backrest 14 of the seat 12. The strap 12 can then be tightened (or loosened) to snugly fit around the backrest 14 to inhibit the strap 12 from moving relative to the backrest 14 of the seat 16.

In addition, the Head Rest Apparatus 10 of the present invention has a first head rest assembly 26 slidably mounted to the strap 12 nearingly adjacent the first end 18 of the strap 12 and a second head rest assembly 28 slidably mounted to the strap 12 nearingly adjacent to the second end 20 of the strap 12. The first head rest assembly 26 and the second head rest assembly 28 are movable along the entire length of the strap 12 to a desired location, as desired by the user.

The first head rest assembly 26 of the Head Rest Apparatus 10 of the present invention includes a first mounting sleeve 30 slidably mounted to the strap 12. A first mounting bracket 32 is secured to the first mounting sleeve 30 with an adjustable first head rest support 34 rotatably mounted to the first mounting bracket 32 such that the first head rest support 34 is movable in a general direction away from and toward the backrest 14. A first head rest 36 is mounted to the first head rest support 34. The length of the first head rest support 34 is adjustable to better accommodate the user with the first head rest 36 movable in a general upward and downward direction. The angle of the first head rest 36 relative to the first head rest support 34 is adjustable by means of a rotating joint 38 and releasably lockable in a desired position by a locking lever 40, friction, or other means.

The second head rest assembly 28 of the Head Rest Apparatus 10 of the present invention includes a second mounting sleeve 39 slidably mounted to the strap 12. A second mounting bracket is secured to the second mounting sleeve 39 with an adjustable second head rest support rotatably mounted to the second mounting bracket such that the second head rest support 41 is movable in a general direction away from and toward the backrest 14. A second head rest 42 is mounted to the second head rest support 41. The length of the second head rest support 41 is adjustable to better accommodate the user with the second head rest 42 movable in a general upward and downward direction. The angle of the second head rest 42 relative to the second heat rest support 41 is adjustable by means of a rotating joint and releasably lockable in a desired position by a locking lever, friction, or other means.

Preferably, the first head rest 36 and the second head rest of the Head Rest Apparatus 10 of the present invention measure approximately six (6″) inches in height, five (5″) inches in width, and two (2″) inches in depth or thickness. Each of the first head rest and the second head rest are preferably covered by soft, cushioning slipcovers or “mittens” for the ultimate in plush comfort and support. The machine-washable “mittens” are preferably constructed from a visco-elastic polyurethane foam polymer popularly known as “memory foam” a polymeric foam that, when produced in a higher-density formulation, reacts to the heat of the human body, permitting the foam to mold itself to the body's contours in a few minutes. In lower-density formulations, memory foam is sensitive not to heat but pressure, and molds more quickly to the body's contours. Because of its “memory” qualities and supportive firmness, the memory foam is a perfect material for orthopedic mattresses and mattress-pads, pillows, and cushions and the perfect choice for the Head Rest Apparatus 10. The foam layer is finished with a zippered, removable, machine-washable slipcover, perhaps in fleece, cotton, or a cotton-polyester blend.

In another embodiment of the present invention, the Head Rest Apparatus 10 of the present invention features a hard, molded-plastic internal frame or skeleton which extends upward and slightly outward, in a shape suggestive of an open hand, from a flat, elongated, rectangular tab. The tab is equipped with a rotating joint, such that when not in use, the head rests extend upward, along the side of the seat; and when desired for use, can be pulled and rotated down alongside the user's head. In a permanently mounted version of the Head Rest Apparatus 10, the mounting tab is bolted to the side-frame of the seat being equipped; and the mounting tab features a sliding, pin-and-hole mechanism permitting the Head Rest Apparatus 10 head rests to be raised or lowered. In a portable, carry-on version, the mounting tab is equipped with a pair of stoutly tensioned, U-shaped mounting clips designed to clamp the Head Rest Apparatus 10 to the side of the seat or chair; and elevation adjustments are made by sliding the entire assembly up or down along the side of the seat. Each version of the Head Rest Apparatus 10 might also be equipped with a pivoting, locking side-adjustment, permitting the user to fine-tune the head-rests in terms of the most comfortable angle from the side of the seat.

In still another embodiment of the Head Rest Apparatus 10 of the present invention, the side mounted version for airplanes and the like can include a TV in the headset. This version of the Head Rest Apparatus 10 allows the user to view TV and TV programming while traveling.

In all embodiments of the Head Rest Apparatus 10 of the present invention, then, the traveler has comfortable, soft, cushioning support for either side of the head enabling them to enjoy the rest and relaxation they need but could not otherwise get. Whether installed as permanent equipment to enhance the comfort of airplane, train, or bus seats (and the passenger seats of cars); or produced as an easily installed, easily adjusted carry-along accessory for the frequent traveler, the Head Rest Apparatus 10 is easy to use, adjustable to any passenger's size, age or height, and reliable and steady despite the rigors of a long flight, drive, or ride. With its washable memory-foam “mitten,” the Head Rest Apparatus 10 is easy to care for, and will provide years of dependable service. Thus, the Head Rest Apparatus 10 meets a real need shared by millions of travelers who like to get where they're going, rested and refreshed.

Although this invention has been described with respect to specific embodiments, it is not intended to be limited thereto and various modifications which will become apparent to the person of ordinary skill in the art are intended to fall within the spirit and scope of the invention as described herein taken in conjunction with the accompanying drawings and the appended claims.

1. A head rest apparatus for cradling and supporting a head of a sitting passenger in a seat, the seat having a seat portion and a backrest portion extending from the seat portion, the head rest apparatus comprising:
a strap securable about the backrest portion of the seat;
a first head rest assembly slidably securable to the strap; and
a second head rest assembly slidably securable to the strap;
wherein the first head rest assembly and the second head rest assembly offer the passenger a full measure of support and comfort.

2. The head rest apparatus of claim 1 wherein the strap is adjustable.

3. The head rest apparatus of claim 1 wherein the strap has a first end and a second end, a first buckle portion secured to the first end of the strap and a second buckle portion secured to the second end of the strap, and further wherein the first buckle portion is releasably securable to the second buckle portion to releasably secure the strap about the backrest of the seat.

4. The head rest apparatus of claim 1 wherein the first head rest assembly is slidably mounted to the strap nearingly adjacent the first end of the strap, the second head rest assembly is slidably mounted to the strap nearingly adjacent to the second end of the strap, and further wherein the first head rest assembly and the second head rest assembly are movable along the entire length of the strap to a desired location.

5. The head rest apparatus of claim 4 wherein the first head rest assembly and the second head rest assembly are releasably secured at the desired location by friction between the first head rest assembly and the back rest of the seat and the second head rest assembly and the back rest of the seat, respectively.

6. The head rest apparatus of claim 1 wherein the first head rest assembly has a first mounting sleeve slidably mounted to the strap, a first mounting bracket secured to the first mounting sleeve, an adjustable first head rest support rotatably mounted to the first mounting bracket, a first head rest mounted to the first head rest support and wherein the second head rest assembly has a second mounting sleeve slidably mounted to the strap, a second mounting bracket secured to the second mounting sleeve with an adjustable second head rest support rotatably mounted to the second mounting bracket, a second head rest mounted to the second head rest support.

7. The head rest apparatus of claim 6 wherein the first head rest support is movable in a general direction away from and toward the backrest and the second head rest support is movable in a general direction away from and toward the backrest.

8. The head rest apparatus of claim 6 wherein the length of the first head rest support is adjustable with the first head rest movable in a general upward and downward direction and the length of the second head rest support is adjustable with the second head rest movable in a general upward and downward direction.

9. The head rest apparatus of claim 6 wherein the angle of the first head rest relative to the first head rest support is adjustable by means of a rotating joint and releasably lockable in a desired position and the angle of the second head rest relative to the second head rest support is adjustable by means of a rotating joint and releasably lockable in a desired position.

10. The head rest apparatus of claim 1 and further comprising:
a cushioned first slipcover positioned over at least a portion of the first head rest assembly; and
a cushioned second slipcover positioned over at least a portion of the second head rest assembly.

11. The head rest apparatus of claim 10 wherein the cushioned slipcovers are constructed from a visco-elastic polyurethane foam polymer.

12. A method for cradling and supporting a head of a sitting passenger in a seat, the seat having a seat portion and a backrest portion extending from the seat portion, the method comprising:
securing a strap about the backrest portion of the seat;
slidably securing a first head rest assembly to the strap;
slidably securing a second head rest assembly to the strap; and
offering the passenger a full measure of support and comfort.

13. A head rest apparatus cradling and supporting a head of a sitting passenger in a seat, the seat having a seat portion and a backrest portion extending from the seat portion, the head rest apparatus comprising:
an adjustable strap securable about the backrest portion of the seat;
a first head rest assembly having a first mounting sleeve slidably mounted to the strap, a first mounting bracket secured to the first mounting sleeve, an adjustable first head rest support rotatably mounted to the first mounting bracket, a first head rest mounted to the first head rest support; and
a second head rest assembly having a second mounting sleeve slidably mounted to the strap, a second mounting bracket secured to the second mounting sleeve with an adjustable second head rest support rotatably mounted to the second mounting bracket, a second head rest mounted to the second head rest support;
wherein the first head rest assembly and the second head rest assembly offer the passenger a full measure of support and comfort.

14. The head rest apparatus of claim 13 wherein the strap has a first end and a second end, a first buckle portion secured to the first end of the strap and a second buckle portion secured to the second end of the strap, and further wherein the first buckle portion is releasably securable to the second buckle portion to releasably secure the strap about the backrest of the seat.

15. The head rest apparatus of claim 13 wherein the first head rest assembly is slidably mounted to the strap nearingly adjacent the first end of the strap, the second head rest assembly is slidably mounted to the strap nearingly adjacent to the second end of the strap, and further wherein the first head rest assembly and the second head rest assembly are movable along the entire length of the strap to a desired location.

16. The head rest apparatus of claim 15 wherein the first head rest assembly and the second head rest assembly are releasably secured at the desired location by friction between the first head rest assembly and the back rest of the seat and the second head rest assembly and the back rest of the seat, respectively.

17. The head rest apparatus of claim 13 wherein the first head rest support is movable in a general direction away from and toward the backrest and the second head rest support is movable in a general direction away from and toward the backrest.

18. The head rest apparatus of claim 13 wherein the length of the first head rest support is adjustable with the first head rest movable in a general upward and downward direction and the length of the second head rest support is adjustable with the second head rest movable in a general upward and downward direction.

19. The head rest apparatus of claim 13 wherein the angle of the first head rest relative to the first head rest support is adjustable by means of a rotating joint and releasably lockable in a desired position and the angle of the second head rest relative to the second head rest support is adjustable by means of a rotating joint and releasably lockable in a desired position.

20. The head rest apparatus of claim 13 and further comprising:
a cushioned first slipcover positioned over at least a portion of the first head rest assembly; and
a cushioned second slipcover positioned over at least a portion of the second head rest assembly.
